(19) United States
(12) Patent Application Publication
(10) Pub. No.: US 2011/0170526 A1
(43) Pub. Date: Jul. 14, 2011

(54) Base stations backhaul network with redundant paths

(75) Inventors: Tzu-Chiang Hsieh, Freemont, CA (US); Brett Lewis, Honolulu, HI (US); John Lovberg, San Diego, CA (US)

(73) Assignee: Trex Enterprises Corp

(21) Appl. No.: 12/930,177

(22) Filed: Dec. 30, 2010

Related U.S. Application Data
(63) Continuation-in-part of application No. 12/228,114, filed on Aug. 7, 2008.
Application No. 12/228,114 is a continuation-in-part of application No. 12/928,017, filed on Nov. 30, 2010.

(51) Int. Cl. H04W 40/00

(52) U.S. Cl. 370/338; 370/328

(57) ABSTRACT

A high bandwidth, low latency middle-mile, last mile core communications network providing low-cost and high-speed communications among the users of the network. Embodiments of the invention include a number of network access points located at a number of spaced apart sites. At least some of these network access points in the network are in communication with each other via wireless radio links. The network provides backhaul communication between at least one communication switching center and a number of base stations.

### CROSS REFERENCE TO RELATED APPLICATIONS

This application is a continuation in part of U.S. patent application Ser. No. 12/228,114 filed Aug. 7, 2008, Ser. No. 12/928,017 filed Nov. 30, 2010 and Ser. No. ______ filed Dec. 28, 2010 all of which are incorporated herein by reference.

The present invention relates to communication systems and in particular to communication systems providing backhaul especially cellular backhaul.

### BACKGROUND OF THE INVENTION

### Telecommunication Networks

A telecommunications network is a collection of terminals, links and network access points which connect together to enable telecommunication between users of the terminals. Terminals refer to the end devices where information is originated or terminated. Devices such as phones, computers, printers, smart phones, personal digital assistants are all in the category of terminals. A network access point (sometimes called a “NAP” or a “node”) refers to the access point of a network where telecommunication information can pass through from its source terminal to its destination terminal. Hardware and software are used to control the transmission of information at each node. A link refers to the interconnection between two nodes. Modern telecommunication includes voice, video and data communications.

A telecommunication network may use circuit switching or packet switching. In case of circuit switching, a link path is decided upon before the data transmission starts. The system decides on which route to follow and transmission goes according to the path. For the whole length of the communication session between the two communicating terminals, the route is dedicated and exclusive, and released only when the session terminates. In the case of packet switching, a link path is not pre-determined. The Internet Protocol (IP), just like many other protocols, breaks data into chunks and wraps the chunks into structures called packets. Each packet contains, along with the data load, information about the IP address of the source and the destination terminals, sequence numbers and some other control information. Once they reach their destination, the packets are reassembled to make up the original data again. In packet switching, the packets are sent towards the destination irrespective of each other. Each packet has to find its own route to the destination. There is no predetermined path; the decision as to which node to hop to in the next step is taken only when a node is reached. Each packet finds its way using the information it carries, such as the IP address of source and destination terminals.

Each terminal in the network must have a unique address so messages or connections can be routed to the correct recipients. The links connect the nodes together and are themselves built upon an underlying transmission network which physically pushes the message across the links. Packets are generated by a sending terminal, then pass through the network of links and nodes until they arrive at the destination terminal. It is the job of the intermediate nodes to handle the messages and route them down the correct links toward their final destination.

The packets consist of control and bearer parts. The bearer part is the actual content that the user wishes to transmit (e.g. some encoded speech, or a segment of an email, or other digital data) whereas the control part instructs the nodes where and possibly how the message should be routed through the network. A large number of protocols have been developed over the years to specify how each different type of telecommunication network should handle the control and bearer messages to achieve this efficiently. All telecommunication networks are made up of five basic components that are present in each network environment regardless of type or use. These basic components include terminals, telecommunications processors, telecommunications channels, computers, and telecommunications control software. Early networks were built without computers, but late in the 20th century their switching centers were computerized or the networks were replaced with computer networks. With the growth of the Internet, a protocol called the Transmission Control Protocol and Internet Protocol (TCP/IP) has become the dominant representation for network design.

### TCP/IP Protocol

An Internet Protocol Suite (IPS) is a set of communication protocols used for the Internet and other similar networks. The most commonly known IPS is TCP/IP, named after two of the most important protocols in it, the Transmission Control Protocol (TCP) and the Internet Protocol (IP). TCP carries the information of the access points between which an IP packet/message is transferred or passing through, whereas IP contains the data, the IP address of source and destination terminals between which a packet/message is transferred across one or more networks and other information including the type of service. Terminals attached to a network using TCP/IP protocol are addressed using IP addresses. TCP is the protocol on which major Internet applications (such as the World Wide Web, e-mail, and file transfer) rely. Telecommunication networks can be connected together to allow users seamless access to resources that are hosted outside of the particular provider to which they are connected. There are many different network structures on which TCP/IP can be use to efficiently route messages, for example:
wide area networks (WAN)
metropolitan area networks (MAN)
local area networks (LAN)
campus area networks (CAN)
virtual private networks (VPN)

### Network Layers

In the early days of networking, International Organization for Standardization (ISO) developed a layering model, called Open Systems Interconnection (OSI), to meet the needs of network designers. The OSI model defines seven layers. The TCP/IP model performs the same duties with four layers. The TCP/IP layers are commonly known as:
Layer 4 Application Layer—Specifies how a particular application uses a network;
Layer 3 Transport Layer—Specifies how to ensure reliable transport of data;
Layer 2 Internet Layer—Specifies packet format and routing;
Layer 1 Link Layer—Moves packets through Internet interfaces.

The layers work together by encapsulating and de-encapsulating data, and passing the results onto the next layer so that it can be transferred from a user application down to a transmitted signal, and then transformed back again into data useable by a user application at the other end of the connection. In the sending device, application data is transformed from familiar text to binary data in preparation for being converted to a transmittable signal (in TCP/IP, this is a part of the generalized application layer). After that point each layer receives that binary data and wraps its own header around the data, encapsulating it into a packet/message the corresponding layer at the receiving terminal/host device can understand. These headers contain flags and values that those layers use for managing the transmission of the messages. For example a network layer's IP packet header contains values for source and destination IP addresses. As the message progresses down through the layers, each layer encapsulates the data it receives into the format of its own message, and sends it to the layer below. This repeats until the message is sent to the link layer, where it is transformed for the last time into an electrical or optical signal, and it is sent towards its destination. When the signal arrives at its destination, the signal is decoded, and then the message goes up through the layers in reverse order compared to the sending terminal/host device. In the receiver, each layer de-encapsulates the messages, meaning that it examines the values in the headers, performs any necessary actions, and then removes the payload in the message and sends the payload to the layer above it. This repeats until all the messages/packets are received by the user application on the receiving terminal/host device, and at that point the messages/packets are re-assembled in a format useable to that application.

### Gigabit Ethernet

Gigabit Ethernet builds on top of the earlier Ethernet protocols, but increases speed tenfold over Fast Ethernet (100 Mbps) to 1000 Mbps, or 1 gigabit per second (1 Gbps). Gigabit Ethernet is designed for use with optical fibers operating over long distances with long wavelength lasers and short wavelength lasers and with shielded copper cable for short distances such as about 25 meters or less. Gigabit Ethernet adheres to the frame format of earlier Ethernet protocols but utilizes the high speed interface technology of Fibre Channel. This setup maintains compatibility with the installed base of Ethernet and Fast Ethernet products, requiring no frame translation. Ten Gigabit Ethernet provides another factor of ten increase in data rate up to 10 Gbps.

### Ethernet Switches

Ethernet switches have been available for several years from suppliers such as Cisco Systems and Ciena Corporation for supporting Ethernet networks. For example the Ciena Model CN 3940 switch features high capacity switching with 24 Gigabit Ethernet user ports in a compact single rack unit. At each of the ports the switch has an SFP connector for connecting high speed Ethernet equipment and a separate RJ-45 connector for connecting lower data rate equipment. The switch uses Carrier Sense Multiple Access with Collision Detection (CSMA/CD) to control access of the connected communication equipment to the network it is supporting. CSMA/CD is a network protocol in which a carrier sensing scheme is used at each interface to permit multiple access without collisions. During the gap between transmissions, each interface (i.e. the equipment at each of the connected ports) has an equal chance to transmit data. If a transmitting station detects another signal while transmitting a frame, it stops transmitting that frame, transmits a jam signal, and then waits for a random time interval before trying to send that frame again. These Ethernet switches can be programmed to encapsulate and tag incoming packets to direct the packets to specific ports of itself and/or other Ethernet switches at distant network access points. The switches can also be programmed to monitor the tags of all incoming network transmissions and pull off any packets directed to any of the users that are connected to one of its ports. Packets then can be conveyed to the respective users via the appropriate switch output ports.

### Cellular Networks

A cellular network is a communication network distributed over land areas called “cells”; each cell served by one or more fixed-location transceivers each location known as a cell site or base station. When joined together these cells provide radio coverage over a wide geographic area. This enables a large number of people with fixed and portable transceivers (such as mobile phones, office computers, laptop computers, etc.) to communicate with each other and with fixed transceivers and telephones anywhere in the network, via the base stations and to communicate with other equipment connected to the cellular network including the Internet.

A cellular network is used by an operator to achieve both coverage and capacity for its subscribers. Large geographic cells may be split into smaller cells to avoid line-of-sight signal loss and to support a large number of active phones and other communication equipment in that area. The cell sites may be connected to telephone exchanges, switches or routers, which in turn connect to the public telephone network or the Internet. In cities, each cell site may have a range of up to approximately ½ mile; while in rural areas, the range could be as much as 5 miles. It is possible that in clear open areas, a user may receive signals from a cell site 25 miles away.

A variety of multiplexing schemes are in use including: frequency division multiplex (FDM), time division multiplex (TDM), code division multiplex (CDM), and space division multiplex (SDM). Corresponding to these multiplexing schemes are the following access techniques: frequency division multiple access (FDMA), time division multiple access (TDMA), code division multiple access (CDMA), and space division multiple access (SDMA).

### (a) WiMax and LTE Technology

WiMax (Worldwide Interoperability for Microwave Access) is a wireless technology that operates in the 2.5 GHz, 3.5 GHz and 5.8 GHz frequency bands, which typically are licensed by various government authorities. WiMax is based on a radio frequency technology called Orthogonal Frequency Division Multiplexing (OFDM), which is a very effective means of transferring data. WiMax is a standard-based wireless technology that provides high throughput broadband point to multipoint connections over relatively long distances up to a few kilometers. WiMax can be used for a number of applications, including “last mile” broadband connections, hotspots and high-speed connectivity to the Internet for customers. It provides wireless metropolitan area network connectivity at speeds up to 20 Mbps and WiMax base stations on the average can cover 5 to 10 km. Typically, a WiMax base station consists of electronics, a WiMax tower and a WiMax transceiver programmed to connect Internet customers of a service provider within the service area of the base station. Information accumulated at the base station must be transmitted to and from facilities of the service provider. A variety of communication facilities (including fiber optics, cable and twisted pairs) are used by the service providers to connect the base stations to the rest of the Internet. These communication facilities are sometimes referred to as “trunk lines”.

LTE is a technology similar to WiMax. LTE stands for “long term evolution”. So far, Vodafone, Verizon, and AT&T have declared their support for LTE technology and intend to adopt it as their next-generation mobile communications technology. Intel and various manufacturers of customer premise equipment have been the main supporter for WiMAX, mainly in Asian and European countries. Clearwire's WiMAX service is available in major US cities and offers 120 MHz on the 2.6 GHz band, while LTE is not expected to be extensively available until 2013. In terms of technology, WiMAX and LTE are very similar, with major differences occurring in transmission speed and the openness of each network. LTE is faster, but WiMAX is more wide spread. WiMAX is already commercially available, while LTE is still under construction.

### Information Transmission

To transmit a typical telephone conversation digitally utilizes about 5,000 bits per second (5 Kbits per second). Music can be transmitted point to point in real time with good quality using MP3 technology at digital data rates of 64 Kbits per second. Conventional video can be transmitted in real time at data rates of about 5 million bits per second (5 Mbits per second). High Definition (HD) video may require a delivery rate at 45 or 90 Mbps.

Companies, such as line telephone, cellular telephone and cable companies, which transmit information for hundreds, thousands or millions of customers, build trunk lines to handle high volumes of information. These trunk lines may carry hundreds or thousands of messages simultaneously using multiplexing techniques. Thus, high volume trunk lines must be able to transmit in the gigabit (billion bits, Gbits, per second) range. Most modern trunk lines utilize fiber optic lines. A typical fiber optic line can carry about 1 to 10 Gbits per second and many separate fibers can be included in a trunk line so that fiber optic trunk lines can be designed and constructed to carry any volume of information desired virtually without limit. However, the construction of fiber optic trunk lines is expensive (sometimes very expensive) and the design and the construction of these lines can often take many months, especially if the route is over private property or produces environmental controversy. Often the expected revenue from the potential users of a particular trunk line under consideration does not justify the cost of the fiber optic trunk line. Digital microwave communication has been available since the mid-1970's. Service in the 18 to 23 GHz radio spectrum is called “short-haul microwave” providing point-to-point service operating between 2 and 7 miles and supporting between four to eight T1 links (each at 1.544 Mbps). More recently, microwave systems operating in the 11 to 38 GHz band have been designed to transmit at rates up to 155 Mbps (which is a standard transmit frequency known as “OC-3 Standard”) using high order modulation schemes.

### Millimeter Wave Radios for High Speed Point to Point Communication

In 2001 workers at Trex Enterprises Corporation demonstrated a millimeter wave communication link that provided gigabit-per-second wireless communication over several miles and were awarded U.S. Pat. No. 6,556,836 describing the link. The frequencies used in Trex millimeter wave link are in the range of about 70 GHz-95 GHz. The physical coverage of Trex millimeter wave link is typically in the range of 1 to 5 miles. Trex millimeter wave link technologies have been used in commercial products and demonstrated high reliability. Trex workers have included a microwave backup link, provided for continuing the communication in the case of heavy rain which could interrupt the millimeter wave link.

### Metro Ethernet

Ethernet, discussed above, is a set of frame-based computer networking protocols which is frequently used in Local Area Networks (LANs) such as a computer network in a home or office environment. A Metro Ethernet is a network that covers a metropolitan area and that is based on the Ethernet standard. It is commonly used as a metropolitan access network to connect residential and businesses subscribers to a larger service network or the Internet.

### Virtual LAN

A virtual LAN, commonly known as a VLAN (for virtual local area network), is a group of programmable terminal/host devices programmed with special software that allow the devices to communicate, as if they were physically connected, regardless of their physical location. A VLAN has the same attributes as a physical LAN, but it allows for terminal/host devices to be functionally grouped together even if located miles apart. Network reconfiguration can be accomplished through software instead of physically relocating devices.

### Cellular Base Station Backhaul Techniques

Most of the information collected at cellular base stations from customers within the cells must typically be transmitted to some communications point of presence or other location for transmission elsewhere. Similarly provisions must be made for incoming information from the point of presence that is intended for the cellular customers. A typical cell can have hundreds of customers so the amount of information can be huge. This communication between the base stations and the central office is referred to as “backhaul”. In the early days of cellular communication this backhaul was typically handled by telephone lines or microwave radios. Fiber optics and cable has also been used.

FIG. 2 illustrates a prior art system for providing backhaul for cellular base stations of a cellular system. The system relies on a public switched telephone network and connects customers of a cellular system with the World Wide Web (WWW) shown as 290 in FIG. 2. The system includes a mobile telephone switching office (MTSO) 201, and a large number of cellular base stations, two of which are shown as 240, and a much larger number of mobile devices 244 which are utilized by customers of the cellular system. The interconnection between telephone switching office 201 and the base stations 240 can be either the traditional copper wires 231 or more advanced fiber optic lines 210. Typically the backhaul to the telephone switching is provided by T1 lines leased from the telephone company. A T1 line can carry data at a rate of 1.544 megabits per second. T1 lines can be optical or copper. A T1 line might cost between $1,000 and $1,500 per month depending on who provides it and where it goes. As the telecommunication moves beyond voice toward more data centric, especially in light of the explosion of streaming video, video exchanges, on-line gaming and mobile web-browsing, the industry needs to improve the infrastructure to meet the demands. The industry has been slowly upgrading the long range telecommunication pipe 220 to more advanced fiber optic technologies to handle multiple Giga-bits per second rate. However, the upgrade for base station backhauling remains slow due to its high capital investment. Because the demand for high capacity and speed is here already, a low cost solution is absolutely needed and essential to backhaul the cellular base station to meet the demand of new telecommunication usages.

Millimeter Wave Radios for Cellular Information Backhaul U.S. Pat. No. 6,714,800, U.S. Pat. No. 7,062,293 and U.S. Pat. No. 7,769,347 assigned to Applicants' employer, describe systems designed for the use of millimeter wave radios to provide backhaul for customers of cellular systems. These patents are incorporated herein by reference. Those patents described wireless cellular communication systems in which groups of cellular base stations communicate with a central office via a narrow-beam millimeter wave trunk line. The transceivers are equipped with antennas providing beam divergences small enough to ensure efficient spatial and directional partitioning of the data channels so that an almost unlimited number of point-to-point transceivers will be able to simultaneously use the same millimeter wave spectrum. In network described in the patents the trunk line communication links operated within the 92 to 95 GHz or 71 to 76 GHz and 81 to 86 GHz portions of the millimeter spectrum in the same general region. Embodiments described in these patents propose the use of a backup system such as a microwave radio for continuing the communication with the central office in the case of heavy rain which could interrupt the millimeter wave links.

### Last Mile and Middle Mile Communication Services

The United States and many other countries are crisscrossed by many thousands of miles of fiber optic communications links providing almost unlimited telecommunication between major population centers. Telephone companies provide communications services to nearly all of the homes and offices in the United States and many other countries, but existing telephone services in many areas provide only low speed (i.e. low data rate) connections. Communication companies are rapidly improving these last mile services with cable and fiber optic connections but these improvements are expensive and a large number of people are still without access to high speed telecommunication services. Many cellular systems are becoming overloaded due to the increased bandwidth required by the iPhone 4 and similar consumer products and prior art backhaul facilities are fast becoming inadequate.

### The Need

What is needed is a high bandwidth, high speed, cost effective, low latency, middle-mile, redundant communication network to backhaul base stations to large scale telecommunication network infrastructure.

### SUMMARY OF THE INVENTION

The present invention provides a high bandwidth, low latency middle-mile, last mile core communications network providing low-cost and high-speed communications among the users of the network. Embodiments of the invention include a number of network access points located at a number of spaced apart sites. At least some of these network access points in the network are in communication with each other via wireless radio links. The network provides backhaul communication between at least one communication switching center and a number of base stations.

In embodiments the millimeter radio links include two millimeter radios, one transmitting in the frequency range of 71-76 GHz and receiving in the frequency range if 81 to 86 GHz and the other radio transmitting in the frequency range of 81-86 GHz and receiving in the frequency range if 71 to 76 GHz. In these preferred embodiments each millimeter wave radio is equipped with an antenna designed to produce a millimeter wave beam with an angular spread of less than two degrees. A high-speed switch is located at each network access point. The switches include a plurality of ports through which a plurality of network users transmits information through the network. Embodiments include an Ethernet switch programmed to encapsulate and tag incoming packets with a special set of tags which allow the tagging switch and other Ethernet switches in the network to direct the packets to one or more output ports of itself and/or one or more of the output ports of other Ethernet switches at one or more distant network access points without a need for any of the network switches to read any MAC or IP address information contained in the packets. The Ethernet switches are also programmed to remove the special tags prior to transmitting the packets to network users to which the packets are directed. This arrangement of millimeter radio links and Ethernet switches permits communication through the network with almost zero latency

In preferred embodiments the high speed switches are Ethernet service delivery switches and at least some of the millimeter wave radio links are provided with a backup communication which may be microwave radios of T1 lines. In preferred embodiments at least some of the network access points are arranged in one or more rings to provide redundancy and to improve reliability. In preferred embodiments operate at frequencies in ranges of about 71 to 76 GHz and 81 to 86 GHz defining two millimeter frequency bands. In other preferred embodiments the microwave radio is adapted to utilize the same antenna as the millimeter wave radio it is backing up.

Preferably the high speed switches are comprised of firmware which is adapted to recognize tags applied the packets by other of said high speed switches and which is adapted to encapsulate and tag incoming packets with a tag identifying one or more output ports of one or more of said high speed switches to which the packet is directed.

These network access points may also include equipment to allow backward integration to existing non-Ethernet equipment already in place for existing second generation and third generation equipment. Additional communication equipment can be provided for communications with other users and organizations with remote locations outside the coverage range of the network.

The preferred embodiments are low cost because its installation cost per link is much lower than fiber optic links. It is highly reliable because the multi-level redundancy of the network. It is fast, typical a few Giga-bits per seconds using a simple OOK or BPSK modulation scheme; it can be extended to 10 Giga-bits per second using a multi-level modulations such as Differential Phase Shift Keying (DPSK). It is scalable and expandable because additional and parallel links can be installed easily without the constraints of limited availability of transmission media spectrum such as in the case of microwave. Due to the “Pencil Beam” nature of the millimeter wave radio, the interference between two links at the same site (for example on the roof top of the same building) can be avoided with good installation planning. As a result bandwidth capacity can be expanded much easier and cost effectively compared to other technologies including fiber optic lines and microwave radio links.

With the advantages mentioned above, the preferred embodiments of the present invention can be utilized for providing last mile and middle mile communication in a number of applications including specifically the following:

1) Campus to Campus connections: Organizations with scattered facilities can seamlessly link the multiple locations together with a flat network topology and subscribing bandwidth as needed.
2) Rural connections: Rural municipalities to become Internet providers or license a provider to provide the Internet services and other services such as satellite television.
3) Temporary high bandwidth communication: High bandwidth communication can be established within hours or days (not weeks or months) in case of emergencies or for dynamic bandwidth addition or for remote locations or for some temporary build-outs (such as World Expos, outdoor concerts).
4) Business continuity: This network can be used as a secondary network for a business entity to ensure the business continuity in the case of a breakdown of its existing primary network.
5) Expansion of network services: The network can be made available for low cost expansion of the infrastructure of existing network service providers.
6) Expansion of telecom carriers: The network can be utilized by telephone companies to avoid bottlenecks such as those recently caused by increased use of smart phones and to expand their services for example to provide HD video streaming and Internet television.
7) Base stations backhaul: This network can be used by telecommunication service providers to backhaul legacy or future base stations, for example cellular base stations, Wi-Max base station, LTE base station or other kind of base stations in the future.

In addition to backhauling use, it can serve as a core telecommunications network, and additional one or more one-to-multiple wireless base stations can be connected to the core network to enable the connectivity to homes, campuses or office buildings. A wireless link can be spun off from the core network, not a part of the core, to provide private point-to-network access for selected customers.

The network is extremely flexible and can provide any or all of the above services simultaneously.

### BRIEF DESCRIPTION OF THE DRAWINGS

FIG. 1A is a drawing describing a preferred embodiment of the present invention.

FIG. 1B-1F describe other features of the present invention.

FIG. 2 describes a prior art of cellular base stations backhaul technique.

FIGS. 3A and 3B show the use of millimeter wave radio point-to-point links to backhaul cellular base stations.

FIG. 4A to 4C show the use of a millimeter wave network to backhaul cellular base stations.

### DETAILED DESCRIPTION OF PREFERRED EMBODIMENTS

### Preferred Broad Band Wireless Metropolitan Area Networks

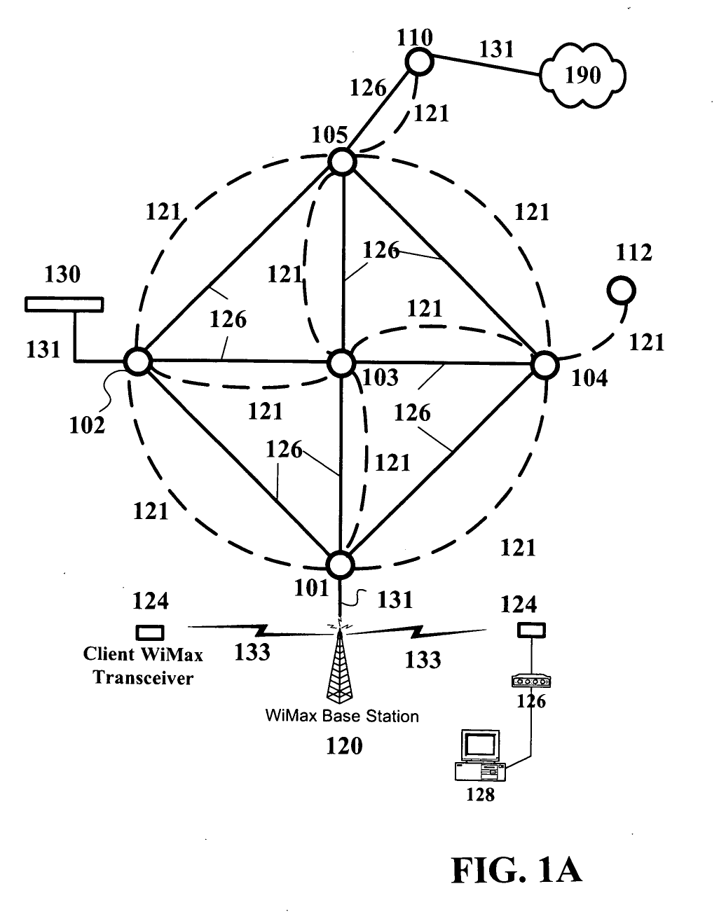

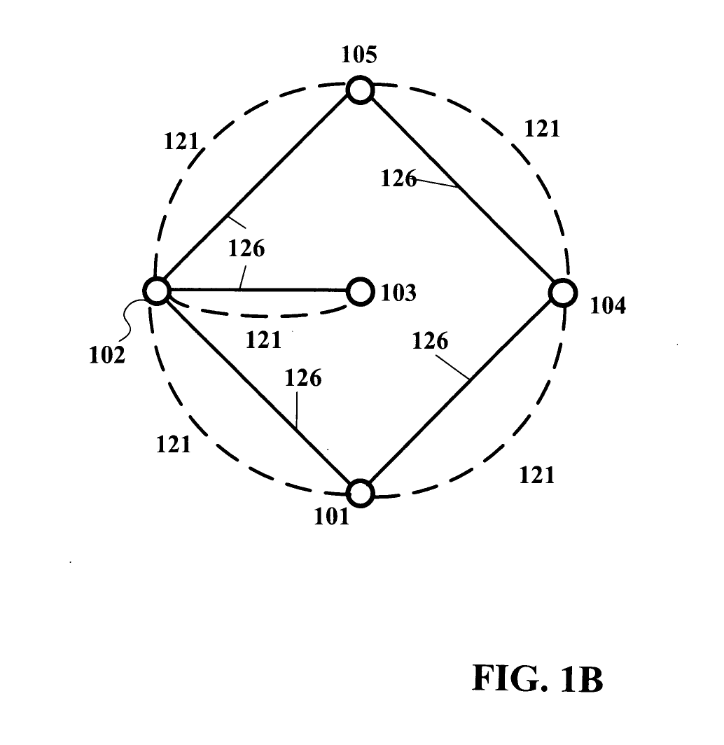

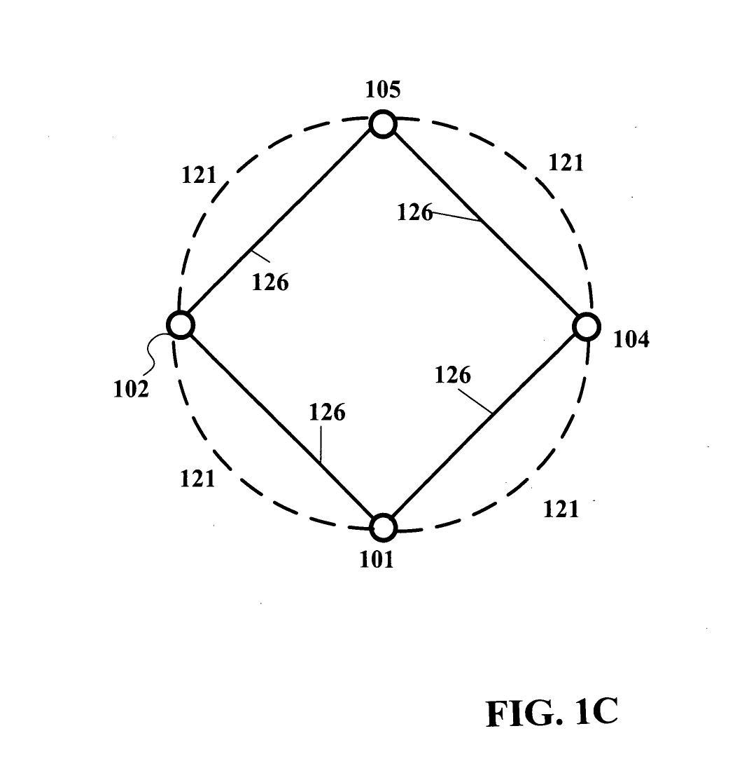

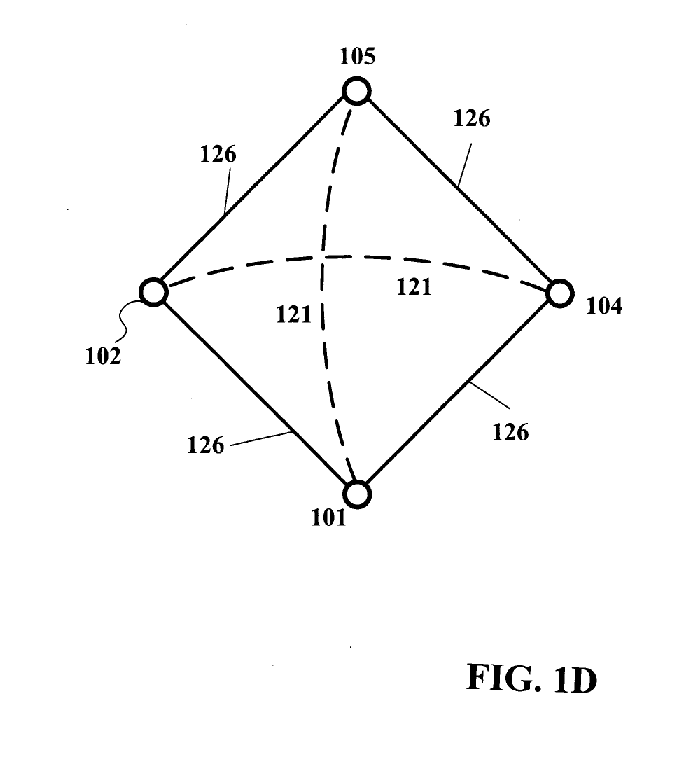

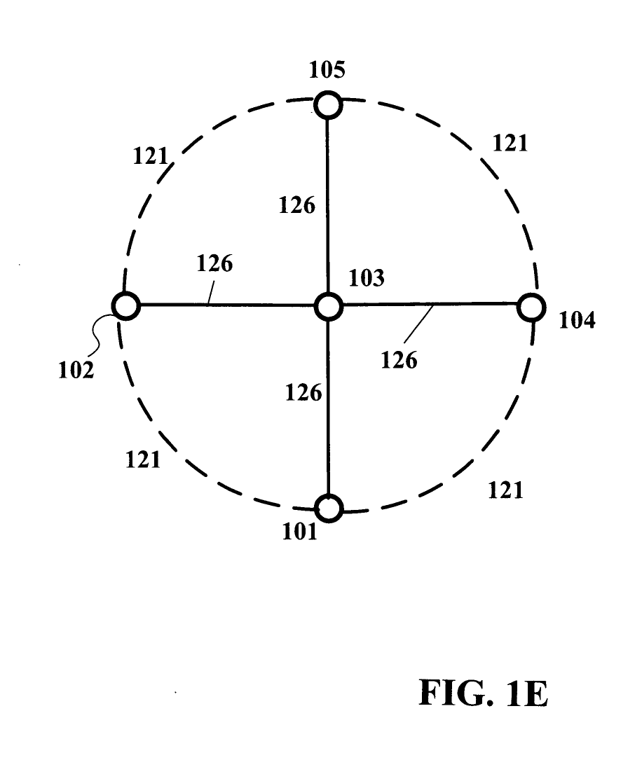

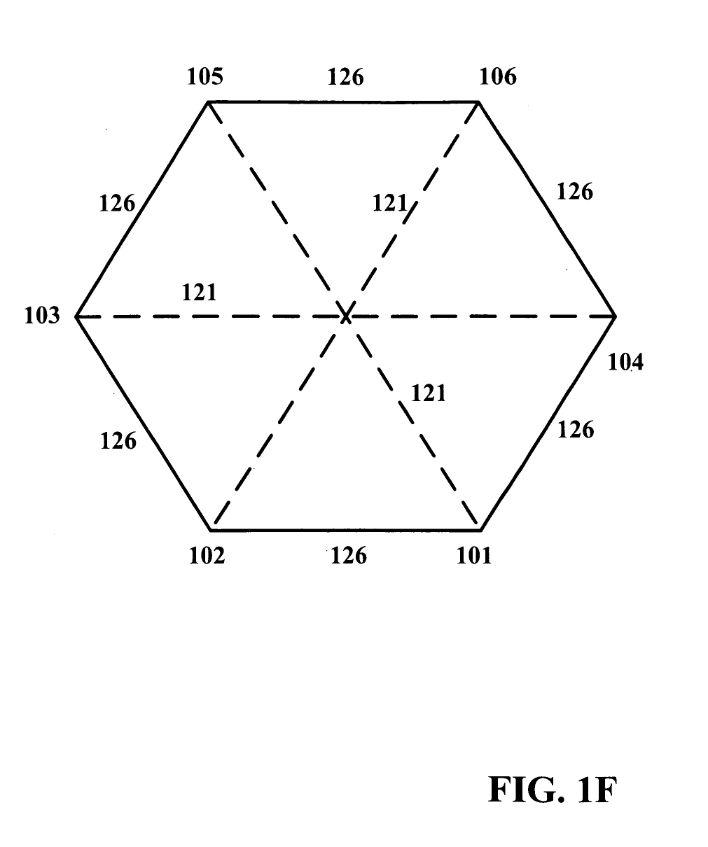

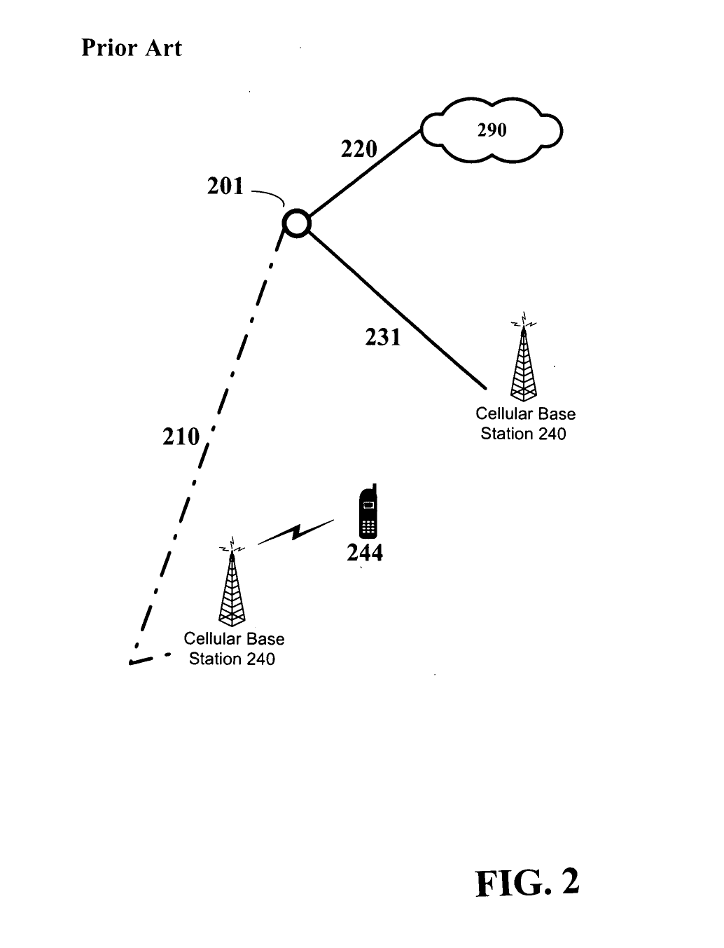

FIG. 1A illustrates the first preferred embodiment of a generic wireless network map according to the present invention. There are five network nodes, labeled 101, 102, 103, 104 and 105 shown in the figure. The nodes can be used to provide link relays to extend coverage range or as network access points. As explained above, the Applicants would treat all nodes as network access points at which clients of Applicant's network can get access to Applicant's network and all network access points are nodes through which information can be relayed. Therefore, unless it is explicitly specified, network nodes and network access points would be used interchangeably in this document. However Applicants will generally refer to nodes which are under the control of a network operator as a “NAP” and nodes that are under the control of a customer of the network operator as a “node”. Solid lines 126's represent the links with the use of pencil beam millimeter wave radio. Dashed lines 121's represent the links by microwave radio. In Applicants' preferred embodiments, the spectral frequency of the pencil beam millimeter wave radio is in the range of 60-100 GHz. The frequency of the microwave radio is in the range of 800 MHz to 10 GHz. An interconnection between node N and node M would be called in this document as node-pair-interconnection (NPI) and be denoted as link (N,M) in this document; for example the interconnection in between node 1 and 2 would be called link (1,2). In FIG. 1A, each link (N,M) is realized by both 121 and 126. Link 121, the microwave radio link, is used as a secondary link in case link 126 fails. Millimeter wave link is the primary link which can provide up to 10 Gbps but it is more susceptible to rain fade. In contrast, the microwave radio link would not be affected substantially by rain, but typically would deliver only up to a few hundred Mbps. The use of both millimeter wave and microwave links for each node pair interconnection would deliver high bandwidth and data rate communications most of the time while ensuring high reliability of network connectivity when the primary links fail due to rain. However, in the areas where heavy rain is rare or non-existing, it would become a trade-off of cost and benefit whether to use millimeter wave alone or millimeter plus microwave for all node interconnections. For example for some interconnections only a microwave link such as link 121 may be appropriate while in other occasions only the millimeter wave link 126 may be preferred. As mentioned in previous sections, the Applicants use a pair of millimeter wave radios to achieve fully duplex communication between two nodes; one radio transmits at frequencies in the range of 70-76 GHz and the other one transmits in the range of 80-86 GHz.

Applicants' clients can get access to the network at selected NAPs. For example, in FIG. 1A, node 110 represents a network client who is connected to the network via NAP 105 using a combination of wireless links by 121 and 126. As the second example, Node 112 may be more cost-effective linked to network via NAP 104 using microwave radio link 121 alone as shown in the figure. The third example, shown in FIG. 1A, is a WiMax Base Station 120, located close to NAP 101 is connected to the network via NAP 101 using a fiber optic, twisted pair or cable 131. WiMax technology is used for point-to-multiple telecommunications; which uses wireless links 133 to multiple client Wi-Max transceivers 124. The fourth example shown in FIG. 1A is node 130 which is connected to the network via NAP 102 using hard wires (such as fiber optic twisted pair or cable) 131. This fourth scenario is most likely applicable where a client server is co-located with a NAP or in close proximity (for example, within the same building) to the NAP and communication links are either readily available or can be cost-effectively installed. The present network, as shown in FIG. 1A, provides a path enabling end users to access the Internet via Applicants' network. An end user is represented by terminal PC 128, which is connected to a WiMax transceiver 124 via a digital modulation/demodulation device 126. Through WiMax Base Station 120 (which may be co-located at NAP 101 and leased to or owned by an Internet service provider 110), the service provider can communicate with the end user 128 via link (101, 103), link (103, 105) and link (105, 110). The service provider has its server connected to the Internet 190 via hard wires 131. With this path, the end user 128 would be able to get access to Internet even though it may be tens of miles away from the facilities of his Internet service provider other than the WiMax base station 120.

FIG. 1B shows a variant of the network shown in FIG. 1A in which link (103, 105), link (103, 104) and link (101, 103) are removed. However, each of the four NAPs continue to be connected by a primary link by millimeter wave radio link 126 and a secondary link by microwave wave radio link 121. Because the transmission between nodes is very fast with very little overhead for communication management, the latency of a path such as link (101, 102) plus link (102, 103) is negligible comparing to a direct link via link (101, 103) in FIG. 1A. Therefore, the cost of setting up link (101, 103) can be saved. The same is true for link (103, 105) and link (103, 104). As a result, the cost of the network setup can be reduced while the network performance may not suffer significantly.

FIG. 1C is another variant where the center NAP 103 is removed but all NAPs remain in communication via both millimeter wave links 126 and microwave links 121. We can estimate the effects on a metropolitan area network where rain-fade would affect a millimeter wave radio link with 0.01% failure in connectivity. A 0.01% failure rate means 50 minutes no-connectivity time per year, i.e., 99.99% (four 9's) connectivity time. If the network is required to achieve at least 99.999% (five 9's, 5 minutes no connectivity per year), the network could deploy a microwave radio link (where rain has negligible effect) as a secondary link. Let us assume, for the sake of illustration, a microwave link could have a 99.9999% (negligible but finite) connectivity. As a result the link between two nodes can have better than eight 9's (0.01%×0.0001% failure probability, i.e. 99.999999%) connectivity time due to the failures of transmission media. In this example, there are two millimeter wave links for each NAP. Due to the two high speed paths to each node, statistically the failure rate of high speed connectivity due to rain fade will decrease to 0.0001% (=0.01%×0.01%). This leads to a high speed and high capacity connectivity of six 9's, 99.9999%. The chance of using the microwave backup will be only for the remaining 0.0001%, which is 3 seconds per year. If the network is fully loaded, during these 3 seconds, the network may possibly experience some packet drops. This failure ought to be rare and not noticeable. However, one can design the millimeter wave link to have a desirable distance which has enough signal-to-noise margins to achieve five 9's. If so, due to the redundancy of this network, the high speed and capacity connectivity will then increase to eight 9's, 99.999999%. This example illustrates the critical role of a redundant network for backhaul, which has much higher reliability than a simple point-to-point backhaul.

Applicants may utilize hybrid links (where a pencil-beam millimeter wave link is backed up with a microwave link) to augment its network service to those clients who have a need of better than five 9's connectivity reliability. With the Applicant's preferred embodiments, such service can be provided at a rate much lower than any other network service providers based upon other communication technologies. The clients needing for better than five 9's reliability may include health providers, banks, and governments.

FIG. 1D is another variant where the radio links are further simplified. In this configuration each NAPs (101, 102, 104 and 105) has three radio links with other NAPs, two millimeter radio links 126 and one microwave radio link 121. For example, for NAP 101, link (101, 102) is a millimeter wave radio link 126, link (101, 104), is a millimeter wave radio link 126 and link (101, 105) is a microwave radio link 121. This network structure also provides high reliability. As an example, to communicate between NAP 101 an NAP 105 data could be routed via link (101, 102) and link (102, 105). If link (102, 105) fails due to downpour of rain, the network can route the data via link (101, 104) plus link (104, 105) or via link (101, 105) or via link (101, 102) plus link (102, 104) plus link (104, 105). The first criterion of the network may be to consider paths achieving the highest possible data transmission speed, then the lowest possible latency. Therefore, link (101, 105) and link (101, 102) plus link (102, 104) plus link (104, 105) options would not be considered until other options are exhausted. Because the first route (link (101, 104) plus link (104, 105)) uses the millimeter wave links 126 for both link (101, 104) and link (104, 105), such route can lead to higher data rate and lower latency comparing to the other two routes, the network would then use it as the secondary route in case of link (102, 105) fails. The same logic is used to determine a complete network routing decision tree. From this structure, one can derive a rule of thumb for a high reliability Gigabits wireless network is to ensure each NAP would have two high speed routes (using millimeter wave radio) to other nodes of the same network and at least one redundant lower speed, but zero or negligible rain failure route (preferably using microwave radio) to another node of the same network. As pointed out above in the FIG. 1D structure, all four NAPs (101, 102, 104 and 105) possess three radio links with other NAPs. This is the basic structure of a triple level of redundancy because each node has three paths to be connected to other parts of the same network. FIG. 1C shows a quadruple level of redundancy. FIG. 1E is another variant where NAP 103 is used as a relay node. All the shorter links, link (101, 103), link (102, 103), link (103, 104) and link (103, 105) are millimeter wave radio links 126. One of the design criteria in the determination of the range of these four links is to maximize their range while maintaining the minimum required link connectivity under the nominal weather pattern in the region. When the shorter link can only be able to meet the minimum requirement in link connectivity, the longer range such as link (104, 105), link (101, 104), link (101, 102) and link (101, 102) would not be able to meet the minimum requirement. For example, if in this region, a pencil beam millimeter wave radio link of 3 miles has 0.001% failure rate due to rain fade. When links (101, 103), (102, 103), (103, 104) and (103, 105) are three miles, the network range would cover about 6 miles. In the configurations of FIG. 1A to 1E, the network is formed by four right isosceles triangles where two lateral sides around the right angle are of equal distance. In this case, the longer side of the triangle would be about 4.3 miles which exceeds the distance of 0.001% failure rate in the region (3 miles in this example). Use of pencil-beam millimeter wave radio link might not the best choice due to rain fade. As a result, microwave radio link 121 may be better used for the longer distance links including links (104, 105), (101, 104), (101, 102) and (102, 105). This network configuration still gives each NAP three radio links, which would provide a triple level of redundancy. This network configuration can be used to extend the network coverage range. It can be understood as follows. Again, we assume that a millimeter wave link of 3 miles would provide 99.999% connectivity in this geometric region. If the longer links is designed to be of around 3 miles such as in FIGS. 1A to 1D, the network coverage would be of about 4.4 miles east to west and north to south. In the case as shown in FIG. 1E, a relay node 103 is used and links (102, 103), (104, 103), (105, 103) and (101, 103) are of a distance of 3 miles. The network coverage would become 6 miles east to west and south to north; which is longer than the range of the configurations shown in FIGS. 1A to 1D. In FIG. 1E, each of NAPs 101, 102, 104 and 105 has one millimeter wave radio link 126 with NAP 103. As such, each of NAP 101, 102, 104 and 105 has one high speed and high capacity communication path, The microwave radio link 121 is used solely to provide substantially close to 100% connectivity to each node.

In FIG. 1F the network is in the shape of hexagon where six sides are of equal distance. The six sides are linked using pencil beam millimeter wave radio 126 and three microwave links 121 are used to connect each pair of nodes opposite across the hexagon. In this configuration, each node, 101, 102, 103, 104, 105 and 106 has two millimeter radio links 126 to two other adjacent NAPs and one microwave link 121 to the node opposite across. This network also provides triple level of redundancy. Such network configuration would ensure substantially close to 100% connectivity, with high speed and high capacity connectivity substantially due to its two millimeter wave radio links to each of the other NAPs.

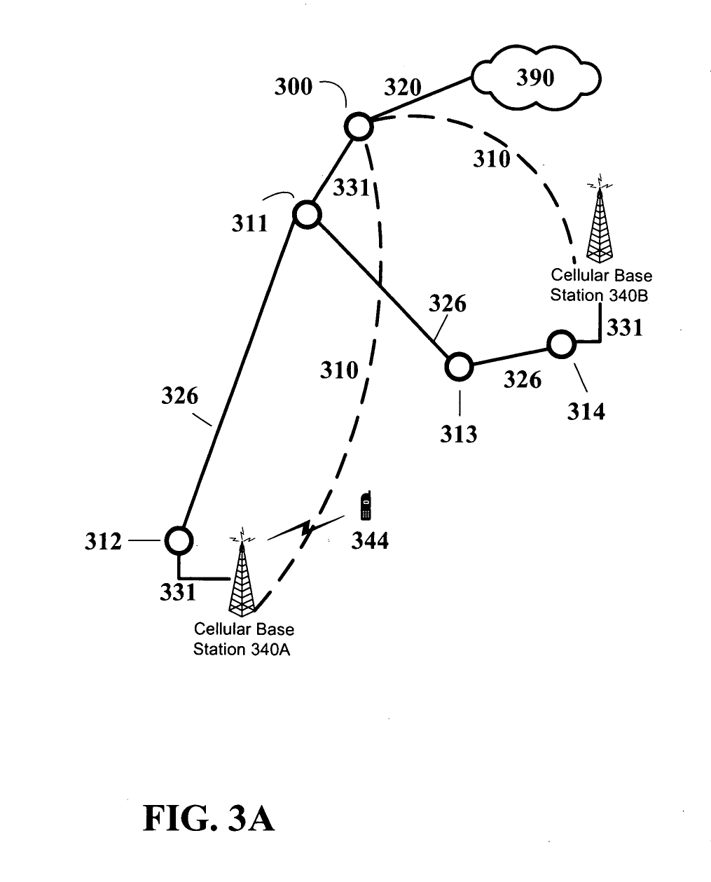

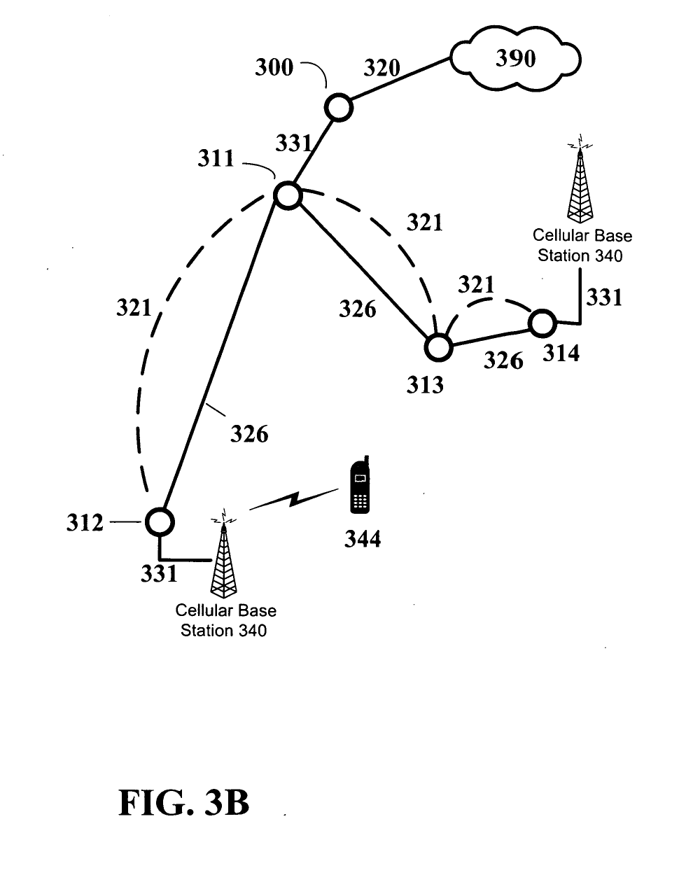

FIGS. 3A and 3B illustrate the use of the point-to-point millimeter wave radio links for cellular base station backhaul. A mobile telephone switching office 300 is co-located with or in close proximity to a millimeter wave radio antenna site 311. The co-location is important because it can ensure a low cost accessibility to 300 from 311, for example within the same building. The link between 300 and 311 can be either cable or high bandwidth fiber optic lines 331. In FIG. 3A, NAP 312 is in direct line of sight to NAP 311 and a millimeter wave radio point-to-point link 326 as proposed above is used. NAP 312 is co-located with a cellular base station 340A and connected by cable or fiber optic lines 331. Mobile devices such as 344 are wirelessly connected to the base station 340A. In case a base station is not in direct line of sight with 311, a relay node can be used. This scenario is illustrated for NAP 314 which is not in direct line of sight with 311; a relay node 313 is used. Millimeter wave radio link 326 is used for both link between 311 and 313 and the link between 313 and 314. Again NAP 314 is co-located with a cellular base station 340B connected by 331. The low speed, low capacity legacy lines 310 (this could be a T1 line or even older telephone lines) are not removed from the existing infrastructure, which can be used as the secondary backup lines in case of the primary millimeter wave radio links fail due to heavy rains.

Due to the nature of rain fade known to the millimeter wave in the range of 70-100 GHz, a secondary link using microwave radio 321, shown in FIG. 3B, can be used as a backup in conjunction with the primary millimeter wave radio link. However, the primary link 326, which has the capability to multiple Gigabits per seconds and is able to provide up to 99.99% link connectivity at the same time, can fulfill the high bandwidth and data rate needs majority of time. The backup link is only installed to ensure the total link connectivity during the 0.001% chance of failure due to rain fades. In FIG. 3B, the legacy lines to backhaul the base stations are removed. However, it would be obvious to keep them connected to provide a triple level redundancy to ensure link connectivity.

However, the millimeter wave radio links used in the examples illustrated in FIGS. 3A and 3B are still for point-to-point. Each base station is backhauled only by a high speed millimeter wave radio link or a combination of millimeter wave and microwave radio links. The secondary links, either a microwave radio or the legacy T1 line, can ensure the link connectivity but not the speed and bandwidth when the primary link fails. Therefore, it is desirable to have the cellular base stations be backhauled by a redundant, high speed and high bandwidth wireless network so high speed and high bandwidth communications can be ensured not just link connectivity.

### Base Station Backhaul by Wireless Metropolitan Area Networks

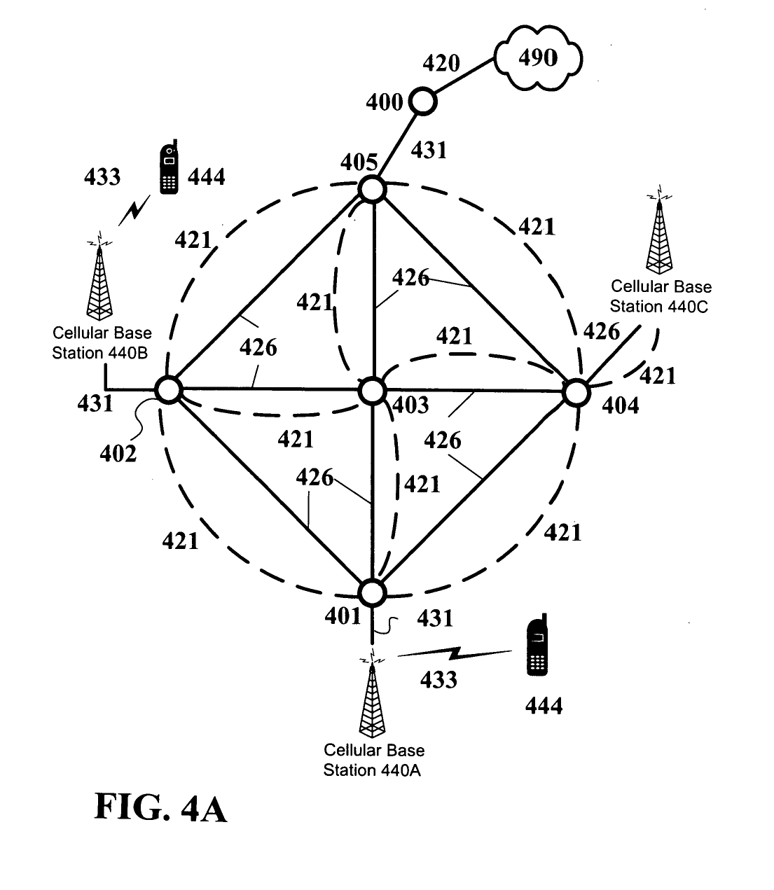

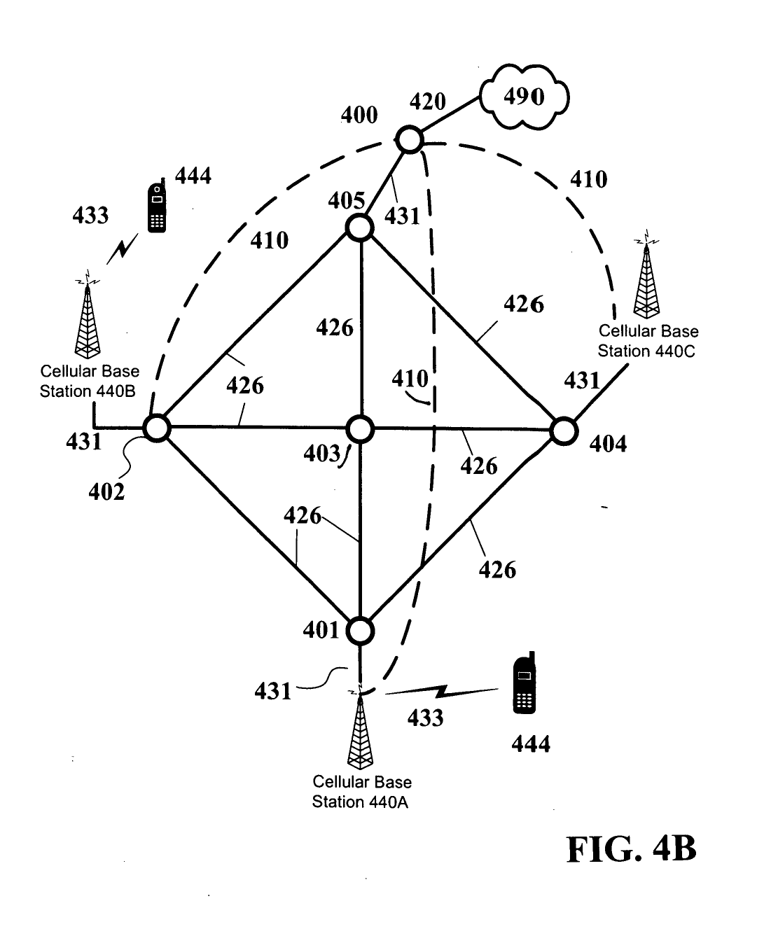

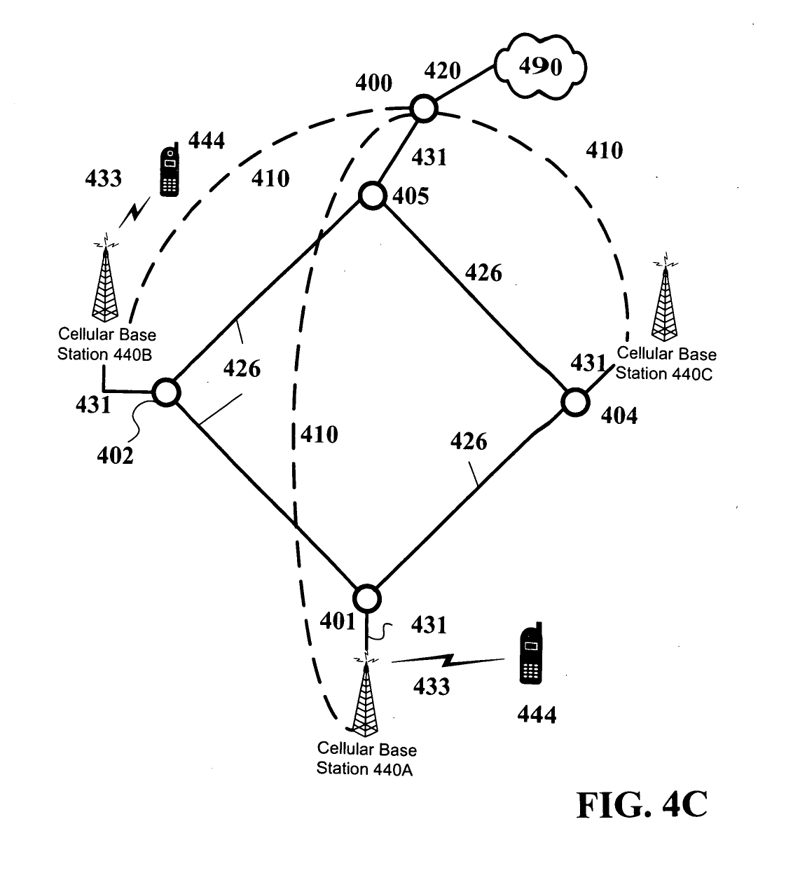

FIG. 4A illustrates a generic architecture for base station backhauling with the use of a network of the type shown in FIG. 1A. In FIG. 4A, a mobile telephone switching office 400 is co-located with a NAP 405 of Applicant's network where a high speed and high capacity wired connection 431 between 400 and 405 is either available or can be cost-effectively installed due to their co-location or proximity. Two cellular base station 440A and 440B are co-located with or in close proximity to two of the network NAP's, 401 and 402 respectively. To illustrate another possible scenario, in FIG. 4A, a base station 440C is not co-located with NAP 404. Instead, a combination of millimeter wave radio 426 and microwave link 421 is used to make connection between this base station and NAP 404. This scenario may happen when a base station is not in line of sight with the NAP 405 in close proximity to the switching office 400. In this preferred embodiment, Applicant uses a combination of millimeter wave and microwave radio links for each link between NAPs. Each of the four NAPs (401, 402, 404 and 405) at the perimeter has six (6) links to other NAPs and the center one 403 has eight (8) links. Such configuration provides very high level of redundancy which could provide well beyond the 99.999% reliability required in the industry. However, one can reduce the cost of construction significantly while maintain better than 99.999% reliability using the network configurations shown in FIG. 1B to 1F. They are all derivatives of the present invention. In FIG. 4A, the low speed legacy lines are removed from the backhaul infrastructure for simplicity.

If there are legacy lines available they could be utilized for additional redundancy. In FIG. 4B, the generic general purpose millimeter network is used solely for base stations backhaul. Again, cellular base stations are used for illustration purpose. The same principle can be applicable to other base stations. In this configuration, only millimeter wave link 426 is used to backhaul the base station 440A, 440B and 440C. The dashed lines 410, in FIG. 4B, represent the legacy T1 lines which would be used as the secondary link in case the high speed, high bandwidth primary links 426 fail for whatever reasons. In FIG. 4B, NAP 403 is used as a relay node and to provide additional routings to increase the network reliability. For the sake of simplicity, all three base stations 440A, 440B and 440C are co-located with NAP 401, 402 and 404 respectively. And the telephone switching office 400 is co-located or in close proximity to NAP 405. Lines 431 are short distance (within a building or in close proximity) and are capable to support high speed and high bandwidth communications with no concern of rain fades. Therefore, whenever a base station is mentioned co-located with or in close proximity of a NAP in this disclosure, the data coming in or out of a base station and the data coming in or out of its connected NAP are treated the same and used interchangeably.

In FIG. 4B, each of the NAPs 401, 402, 404 and 405 has three high speed and high capacity links with the use millimeter wave radio link 426. The legacy lines 410 are kept to provide low speed back up links to each base station. The relay NAP 403 has four high speed and high capacity links. To facilitate the communications between 400 and 440B, the data can be routed via link (405, 402) or via link (405, 403) plus link (403, 402). Let's assume that the distance between NAP 402 and 405 is chosen with sufficient link margin to provide 99.999% link connectivity under the nominal weather condition in this metropolitan area, which is assumed about 3 miles. Then the distance between NAP 402 and 403 (or between 405 and 403) in this example configuration would be around 2.2 miles. For link (405, 402) and link (405, 403) plus link (403, 402), the link connectivity would be significantly higher than 99.999% due to the reduction of distance. Therefore, when link (405, 402) fails due to rain fade, it is highly likely the connectivity between 405 and 402 can be re-routed via link (405, 403) plus link (403, 402). In this example the distance between NAP 402 and 404 is about 4.4 miles which would give the diameter of this network of about 4 to 5 miles. Such network range can definitely support the backhaul needs of one telephone switching office. The multiple routing paths would enable high level of connectivity of high speed and high capacity communications. Due to the physical span of all the network nodes, the effect of rain fade ought to happen only when the NAP connecting to the base station is under heavy down pour. However, with the increase of signal-to-noise ratio due to distance reduction, the high speed and capacity connectivity ought to be higher than five 9's, Therefore, the rain fade effect ought to be negligible and ought to be short lived statistically.

FIG. 4C is a simplified version of FIG. 4B where the relay NAP 403 is removed. In this configuration, each of the NAPs 401, 402, 404 and 404 still has two high speed and high capacity links. Compared to FIG. 4B, this network has fewer alternative routing paths. However, in some areas where rain precipitation is low statistically, such network can be a lower cost backhaul solution while still providing multiple high speed and high capacity routing paths to each base station.

### Advantages of Millimeter Wave Technology

As used herein the phrase “Millimeter Wave Technology” refers to frequencies between 30 GHz to 300 GHz or wavelengths between 1 and 10 millimeters. There are two major advantages of millimeter wave technology over microwave technology. The first advantage is the large amount of spectral bandwidth available. The bandwidth currently available in the 71 GHz to 76 GHz and 81 GHz to 86 GHz bands, a total of 10 GHz, is more than the sum total of all other licensed spectrum available for wireless radio communication. With such wide bandwidth available, millimeter wave wireless links can achieve capacities as high as 10 Gbps full duplex, which is unlikely to be matched by any lower frequency radio technologies. (One of the Applicants and a fellow worker have recently designed a 10 Gbps millimeter wave radio utilizing an eight-state phase modulation scheme described in U.S. patent application Ser. No. 12/928,017.) The availability of this extraordinary amount of bandwidth also enables the capability to scale the capacity of millimeter wave wireless links as demanded by market needs. Typical millimeter wave products commonly available today operate with spectral efficiency close to 1 bit/Hz. However, as the demand arises for higher capacity links, millimeter wave technology will be able to meet the higher demand by using more efficient modulation schemes. The second advantage is the limited width and range of the radio beam. With a two-foot antenna, beam widths are about one-half degree and the range is limited to about 10 miles or less. This means that many millimeter wave radios can be used in a single network all operating over the same frequency bands but pointed in different directions or originating or terminating at different points.

In preferred embodiments Applicants expect to deploy their millimeter wave technologies in a honeycomb (referred to as comb) architecture with a single cell as shown in FIG. 1F. This allows Applicants' networks to trunk multiple gigabits of data per second for delivery. The networks have multiple access points, thereby creating a multi redundant network topology allowing for higher resiliency (self-healing network). These networks of millimeter wave radios become the foundation of Applicants' core Metro Ethernet network. Applicants offer a very high bandwidth and high availability core network and easily add additional communication channels almost without limit to provide additional services on top of the core network.

### Advantage of Circuit Switching

With circuit switching as described above for preferred embodiments of the present invention, latency is almost zero as described above. No software is required in the actual transfer of information packets. Routes are programmed in advance. The information arrives at its destination in the network in the correct sequence. No reassembly is required. The network therefore can easily handle voice transmission and streaming video, both of which can be difficult or impossible with packet switching. With circuit switching as described above the network operator can contract with users to provide specified amounts of bandwidth with a very high probability that that bandwidth will be available when needed by the customer and with almost zero latency.

Applicants believe that its circuit switching provides increased security as compared to packet switching for the information being transmitted through the network. This is because the routes through the network are set in advance by the network and not by the packets. The network controls the firmware in the circuit switches so that information entering the network through a particular port is directed only to specified exit port or ports. The network operator can assure its customers that the customers' information entering a port assigned to the customer will exit the network only at exit ports assigned to the customer. Other customers of the network never get to see the packets. The portions of the information routes beyond the ports are in the control of the customer. In packet switched networks, packets are typically analyzed by a large number of computer components presenting opportunities to compromise the security of the information contained in the packets.

### Microwave Technology

As used herein the phrase “microwave technology” refers to frequencies between 300 MHz and 38 GHz or wavelengths (i.e. 0.008 meter to 1.0 meter). Licensed microwave wireless Ethernet bridge systems operate with frequencies between 3 GHz to 38 GHz. Typical licensed microwave link frequencies operate within 3.65 GHz (as a point-to-multipoint wireless) and backhaul at 4.9 GHz (public Safety), 6 GHz, 11 GHz, 18 GHz, 23 GHz bands. Applicants operate their long distance links (links over 5 miles) at the 11 GHz, 18 GHz, and 23 GHz licensed bands. This allows Applicants to develop self healing long range service uplinks from one microwave comb to another microwave comb. By doing this Applicants can create extended core connections that provide the ability to disseminate services over vast areas while maintaining the core bandwidth speed needed as well as the network functionality.

### Hybrid Links

Preferred embodiments include hybrid links which combine microwave transceivers with millimeter wave transceivers with an automatic switch over to microwave in case of loss of millimeter wave communication on the link. These hybrid links may be designed for both the millimeter wave transceivers and the microwave transceivers to utilize the same antennas.

### Variations

Although the present invention has been described above in terms of limited number of preferred embodiments, persons skilled in this art will recognize there are many changes and variations that are possible within the basic concepts of the invention. For example, with the principles explained above, one would be able to design alternated networks with different number of NAPs and radio links to achieve multi-level redundancy to meet the customers' needs. In the FIG. 1A example the Applicants use WiMax Base Station 120 as an example in which WiMax Base Station is back-hauled by the Applicants' network. A cellular phone bases station could be substituted for the WiMax station. The same principle is applicable to other future mobile and fixed wireless technologies including Long-term-evolution (LTE) wireless technology. In FIGS. 4A, 4B and 4C, cellular base stations are used for illustration. But, the same network is applicable to other base stations such as WiMax, LTE or other future last mile infrastructure.

Therefore, the reader should determine the scope of the present invention by the appended claims and not by the specific examples described above.

What is claimed is:

1. A telecommunications network providing backhaul information communication between at least one communication switching center and a plurality of base stations, said network comprised of a plurality of network nodes located at spaced apart sites, each node comprising communication equipment adapted to transport information to other nodes in said telecommunication network via routes defining communication paths,
wherein each of said plurality of base stations is adapted to provide information exchange between said telecommunication network and a plurality of network users, via at least one of said nodes defining a base station network access point,
wherein said at least one communication switching center is adapted to provide information exchange between said telecommunication network and one or more other networks, via at least one of the network nodes defining a switching center network access point, and
wherein a plurality of said communication paths are wireless paths.

2. The network as in claim 1 wherein a plurality of the wireless paths is a plurality of millimeter wave links.

3. The network as in claim 2 wherein a plurality of the plurality of millimeter wave links is comprised of beams having an angular spread of less than two degrees.

4. The network as in claim 1 wherein said information exchange between said telecommunication network and said communication switching center network access point is via at least one wired means.

5. The network as in claim 4 wherein said wired means is chosen from a group of wired means consisting of: optical fiber, twisted pair and coaxial cable.

6. The network as in claim 1 wherein said information exchange between said telecommunication network and said communication switching center network access point is via at least one wireless means.

7. The network as in claim 6 wherein said wireless means is chosen from a group of wireless means consisting of: millimeter wave radios, microwave radios and a combination of millimeter wave radios and microwave radios.

8. The network as in claim 1 wherein said information exchange between said telecommunication network and at least one of said base station network access points is via at least a wired means.

9. The network as in claim 1 wherein said information exchange between said telecommunication network and at least one of said base station network access points is via at least a wireless means.

10. The network as in claim 1 wherein at least a plurality of the base stations are cellular base stations.

11. The network as in claim 1 wherein at least a plurality of the base stations are WiMax base stations.

12. The network as in claim 1 wherein at least a plurality of the base stations are LTE base stations.

13. The network as in claim 1 wherein communication switching center is one or a combination of a group of communication switching centers consisting of: a mobile telephone switching office, a telecommunication service provider, wide area network hub and Internet service provider.

14. The network as in claim 1 wherein said other networks includes at least one or a combination of network chosen from the following group of networks: a public telecommunication network, the Internet, wide area network, metropolitan area network, local area network and a network similar to the claim 1 network.

15. The network as in claim 1 wherein the network is adapted to provide at least two communication paths through the network from at least one of the base stations to the communication switching center.

16. The network as in claim 15 wherein at least one of said at least two communication paths comprises a millimeter wave link.

17. The network as in claim 15 wherein at least one of said at least two communication paths comprises a legacy communication means.

18. The network as in claim 1 wherein said backhaul information is comprised of voice, video and data.

19. A cellular communications network providing wireless radio communication among a plurality of users comprising radio communication equipment located at a plurality of spaced apart sites, each site defining a network access point, said radio communication equipment at each of said plurality of spaced apart sites comprising;
1) at least two millimeter wave radio systems, each of said at least two radio systems having an antenna adapted to produce a millimeter wave beam with angular spread of less than two degrees and adapted for providing millimeter wave radio with other millimeter wave radio systems at other network access points,
2) a programmable high-speed communication switch having a plurality of input and output ports,
3) power distribution equipment for providing electric power to said millimeter wave systems and said Ethernet switch and
said radio communication equipment at least some of said plurality of spaced apart sites also comprising a cellular base station comprising a microwave radio transceiver providing microwave communication and adapted to provide point-to-multipoint microwave communication with network base station users located within a region defining a cell or part of a cell, and
said radio communication equipment at least some of said plurality of spaced apart sites also comprising additional communication equipment adapted for communication with other network users.

20. The network as in claim 2 wherein at least a plurality of said high speed communication switches is a plurality of Gigabit Ethernet service delivery switches.
